(19) United States
(12) Patent Application Publication
(10) Pub. No.: US 2016/0258673 A1
(43) Pub. Date: Sep. 8, 2016

(54) REFRIGERATOR WITH IMPROVED ENERGY MANAGEMENT MODE AND METHOD FOR CONTROLLING THE REFRIGERATOR

(71) Applicant: ARCELIK ANONIM SIRKETI, Istanbul (TR)

(72) Inventors: Tolga APAYDIN, Istanbul (TR); Sabahattin HOCAOGLU, Istanbul (TR); Emre OGUZ, Istanbul (TR); Tolga Nurettin AYNUR, Istanbul (TR)

(21) Appl. No.: 15/033,893

(22) PCT Filed: Nov. 1, 2013
(86) PCT No.: PCT/EP2013/072851

§ 371 Date: May 2, 2016

(51) Int. Cl. F25D 29/00; G05B 19/042; F25D 11/02

(52) U.S. Cl. CPC F25D 29/00; F25D 11/022; G05B 19/042; F25D 2600/06; G05B 2219/2654; G05B 2219/2639

(57) ABSTRACT

The present invention relates to a method for controlling a refrigerator (1). The control method according to the present invention comprises a step (S1) of setting a target temperature Tset_frz and a target temperature Tset_ff respectively for a freezer evaporator (2) and a fresh food evaporator (3) by selecting out of a plurality of preset temperatures, wherein the plurality of preset temperatures respectively include: a maximum preset temperature, one or more than one intermediate preset temperature, and a minimum preset temperature respectively for the freezer evaporator (2) and the fresh food evaporator (3).

The present invention relates to a method for controlling a refrigerator, in particular a domestic refrigerator which includes one or more than one freezer evaporator and one fresh food evaporator. The present invention particularly relates a method for controlling energy consumption of the refrigerator.

There is a general increase in energy consumption worldwide. In order to meet the increasing demand, new energy plants are continually installed. However, the energy consumption throughout a day greatly fluctuates. For instance, the domestic electrical consumption is typically high in the evening but low in the night. Therefore, a number of energy plants have to be isolated from the energy network at off-peak intervals or even at intermediate-peak intervals to avoid detrimental impacts on the facilities. Consequently, the operating efficiency of a number of energy plants reduces and the overall energy price increases. In view of the aforementioned fluctuations in the energy consumption, energy companies have developed smart electricity meters and introduced time-of-use rates for electricity in order to shift the energy demand from on-peak intervals to off-peak intervals.

A consumer who opts for time-based rates can operate for instance a washing machine, a clothes dryer or a dishwasher at off-peak intervals to benefit from the time-of-use rates. However, unlike the aforementioned household appliances, a domestic refrigerator must be continually operated. Thus, a consumer cannot profit from the time-of-use rates in as much as the electricity consumption of the refrigerator is concerned.

CN101187519 (A) discloses a conventional domestic refrigerator which includes a compressor, a condenser, a capillary, a freezer evaporator, and a fresh food evaporator which are serially arranged and fluidly connected to each other by respective lines for circulating a refrigerant. The refrigerator further includes a storage device for storing electricity. The electric energy which is supplied by the mains is initially stored in the storage device during an off-peak interval, and subsequently used during an on-peak interval. Thereby, the high rate for electricity during the on-peak interval is circumvented.

In general, the use of an electric storage device increases the cost of a refrigerator. In addition, an electric storage device is vulnerable to aging and ceases to effectively operative within a relatively short time.

An objective of the present invention is to provide a refrigerator and a method for controlling the refrigerator which overcomes the aforementioned problems of the prior art and which enables a consumer to flexibly and reliably profit from time-based rates for electricity without jeopardizing effectiveness of a refrigeration process and a defrost process.

This objective has been achieved by the method for controlling the refrigerator according to the present invention as defined in claim 1, and the refrigerator according to the present invention as defined in claim 15. Further achievements have been attained by the subject-matters respectively defined in the dependent claims.

The control method according the present invention comprises a step of setting a target temperature Tset_frz and a target temperature Tset_ff respectively for the freezer evaporator and the fresh food evaporator by selecting out of a plurality of preset temperatures, wherein the plurality of preset temperatures respectively include: a maximum preset temperature, one or more than one intermediate preset temperature, and a minimum preset temperature respectively for the freezer evaporator and the fresh food evaporator. The control method according the present invention further comprises a step of initiating an energy management mode via the user interface; a step of defining or selecting time-of-use rates for electricity via a user interface; and a step of performing energy management by controlling the refrigeration circuit in accordance with target temperatures T′set_frz and T′set_ff as being rectified based on the time-of-use rates such that an operation duty of the refrigeration circuit is reduced during intervals of high rates and/or increased during interval of low rates, wherein the target temperatures T′set_frz and T′set_ff as being rectified do not fall outside the range inclusively defined by the respective maximum preset temperature and the minimum preset temperature.

In an embodiment, when the target temperature Tset_frz and the target temperature Tset_ff are selected as intermediate preset temperatures by the user, the energy management mode temporally reduces the target temperatures Tset_frz and Tset_ff in the off-peak interval by a preset temperature to attain additional cooling. Thereby the load on the refrigeration circuit during the on-peak interval and the intermediate-peak is reduced. Thereby, energy costs are saved. In addition, in this embodiment, the energy management mode temporally increases the target temperatures Tset_frz and Tset_ff in the on-peak interval by a preset temperature. Thereby, energy costs are further saved. In addition, in this embodiment, the energy management mode retains the target temperatures Tset_frz and Tset_ff unchanged in the intermediate-peak interval. Thereby a stable refrigeration of the refrigerator is safeguarded.

In an embodiment, when the target temperature Tset_frz and the target temperature Tset_ff are selected as maximum preset temperatures by a user, the energy management mode temporally reduces the target temperatures Tset_frz and Tset_ff in the off-peak interval by a preset temperature to attain additional cooling. Thereby, the load on the refrigeration circuit during the on-peak interval and the intermediate-peak interval is reduced. Thereby, energy costs are saved. In addition, in this embodiment, the energy management mode retains the target temperatures Tset_frz and Tset_ff unchanged in the on-peak interval. Thereby, the food in the freezer/fresh food compartments are reliably refrigerated throughout the on-peak interval without causing any health risks due to insufficient refrigeration. In addition, in this embodiment, the energy management mode retains the target temperatures Tset_frz and Tset_ff unchanged in the intermediate-peak interval. Thereby, a stable refrigeration of the refrigerator is safeguarded.

In an embodiment, when the target temperature Tset_frz and a target temperature Tset_ff are selected as minimum preset temperatures, the energy management mode retains the target temperatures Tset_frz and Tset_ff unchanged in the off-peak interval. Thereby, the food in the freezer/fresh food compartments are refrigerated throughout the off-peak interval without excessive refrigeration. In addition, in this embodiment, the energy management mode temporally increases the target temperatures Tset_frz and Tset_ff in the on-peak interval by a preset temperature. Thereby, energy costs are saved. In addition, in this embodiment, the energy management mode retains the target temperatures Tset_frz and Tset_ff unchanged in the intermediate-peak interval. Thereby, a stable refrigeration of the refrigerator is attained.

In the present invention the target temperature Tset_frz and the target temperature Tset_ff corresponding to the freezer evaporator and the fresh food evaporator can be selected independently from each other. Hence, the energy management mode of the present invention applies separately to Tset_frz and Tset_ff.

According to the control method of the present invention, the operation duty of refrigeration circuit is reduced during the on-peak interval and/or increased during the off-peak intervals. Thereby, a user opting to time-based rates can attain a substantial amount of reduction in energy costs. The control method of the present invention enables substantially constant temperatures in the freezer/fresh food compartments without insufficiently or excessively refrigerating the food. Thus, the rectified target temperatures always fall inside the maximum range defined by the available respective preset temperatures. Thereby, the energy management of the present invention has improved reliability.

Additional advantages of the refrigerator according to the present invention and the control method according to the present invention will become apparent with the detailed description of the embodiments with reference to the accompanying drawings in which:

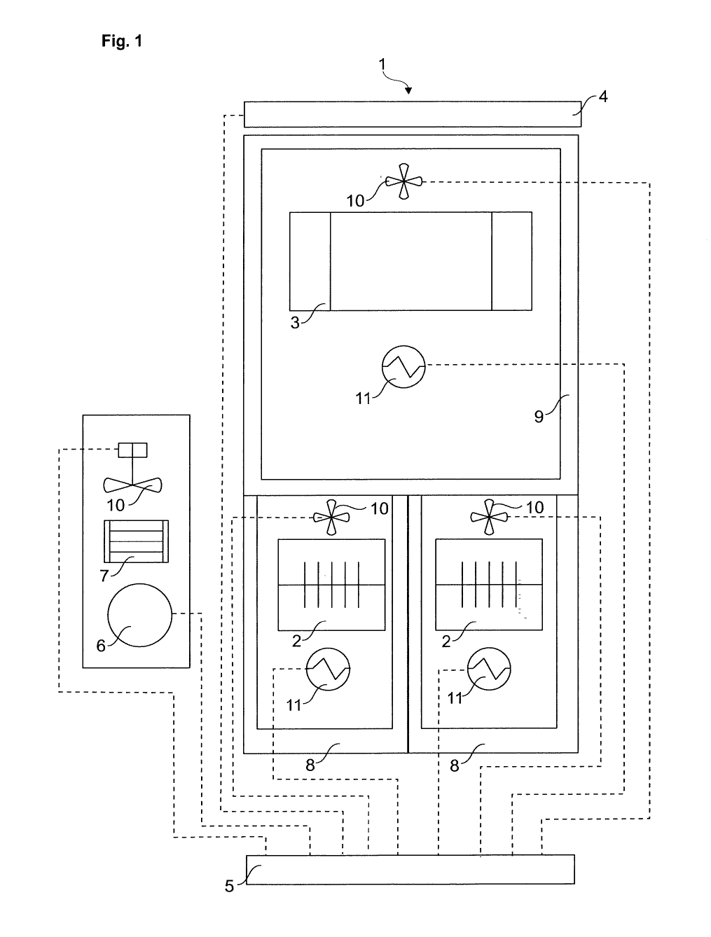

FIG. 1—is a schematic view of the refrigerator according to an embodiment of the present invention;

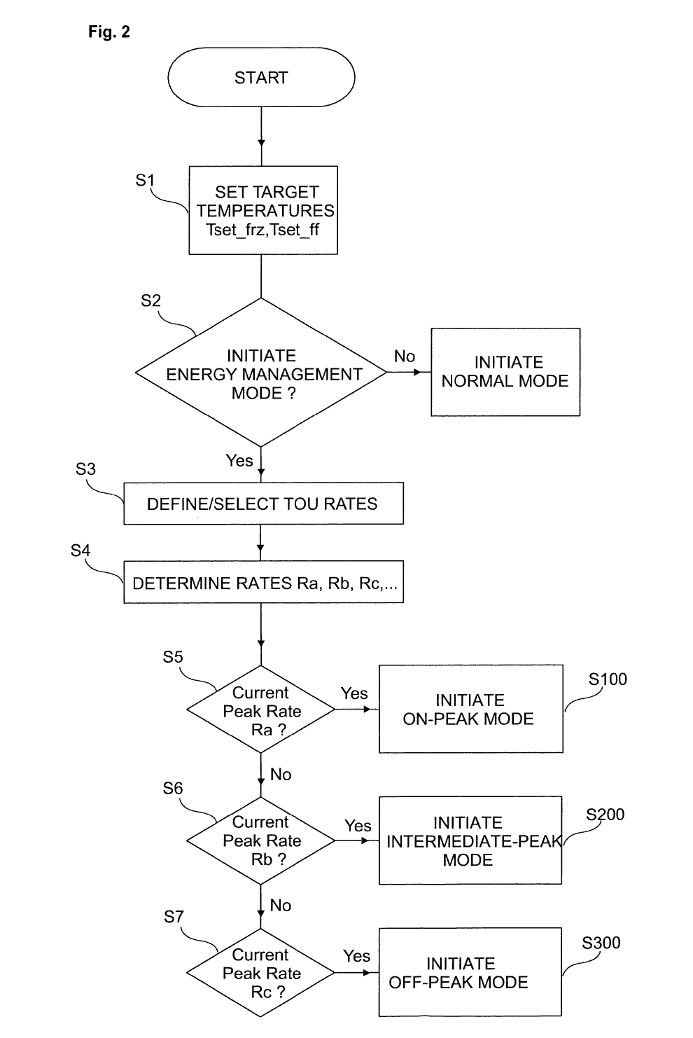

FIG. 2—is a flow chart showing a method for controlling the refrigerator according to an embodiment of the present invention;

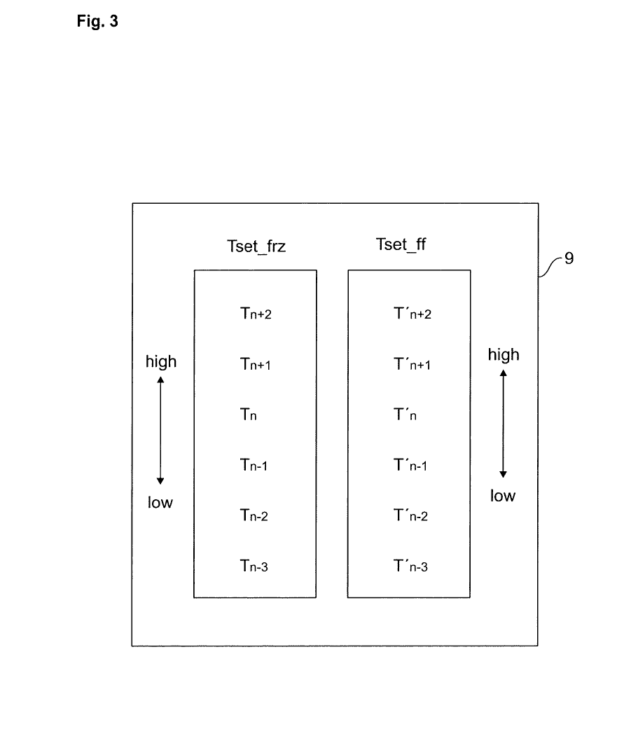

FIG. 3—is a user interface showing a plurality of preset temperatures for selectively and separately setting a target temperature for each of a freezer compartment and a fresh food compartment of the refrigerator according to an embodiment of the present invention;

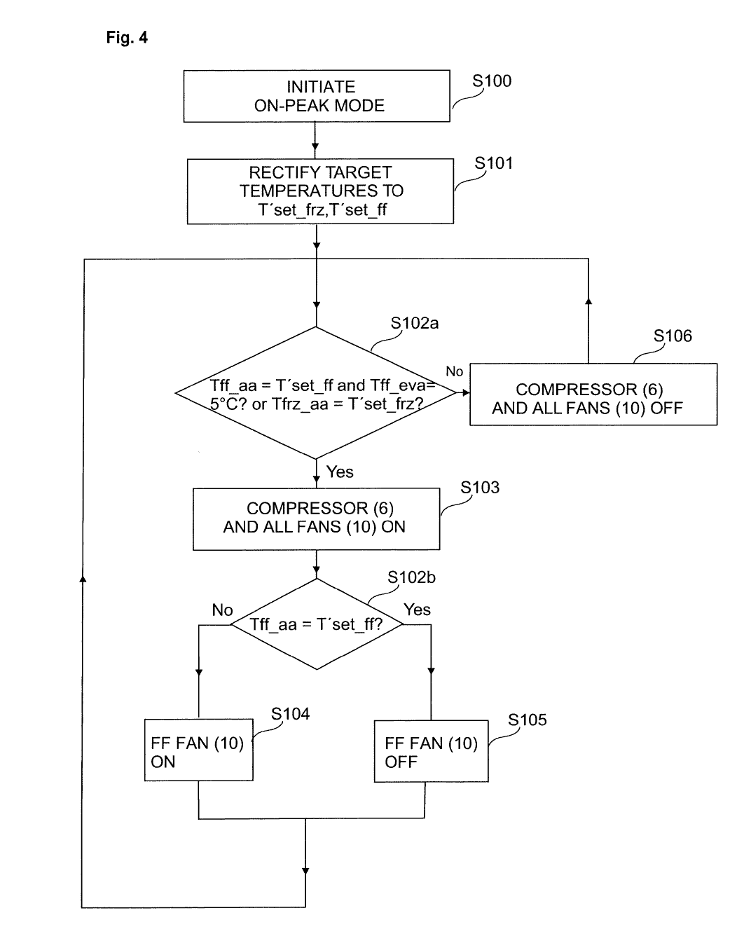

FIG. 4—is a flow chart showing a method for controlling the refrigerator in an on-peak mode according to an embodiment of the present invention;

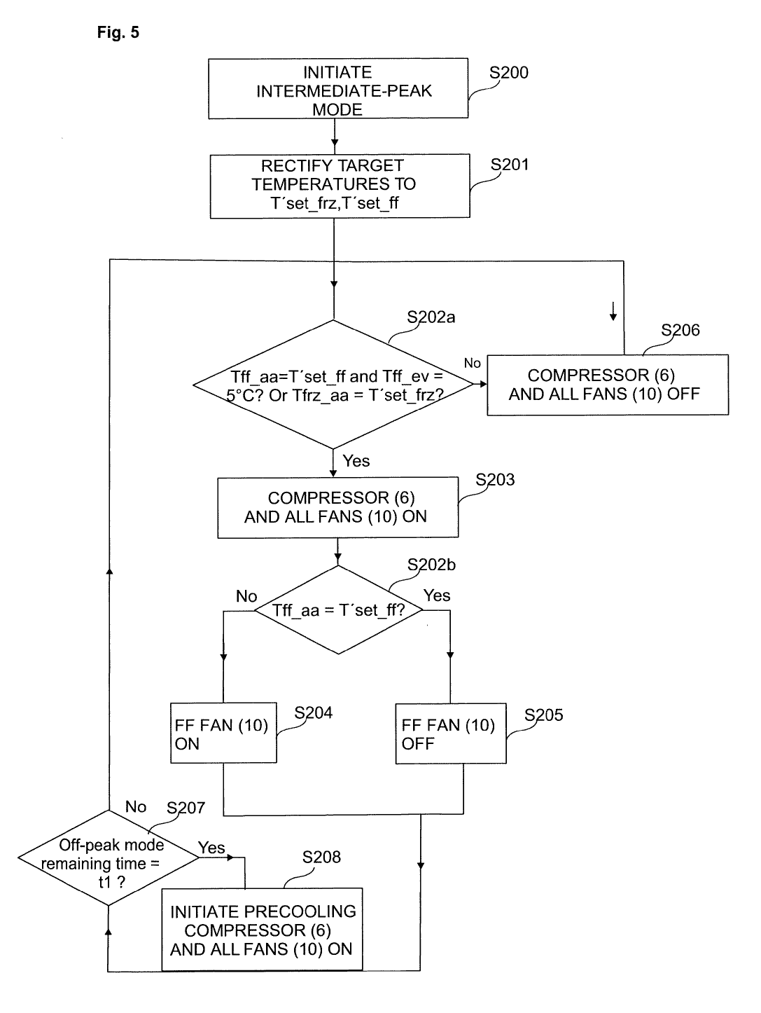

FIG. 5—is a flow chart showing a method for controlling the refrigerator in an intermediate-peak mode according to an embodiment of the present invention;

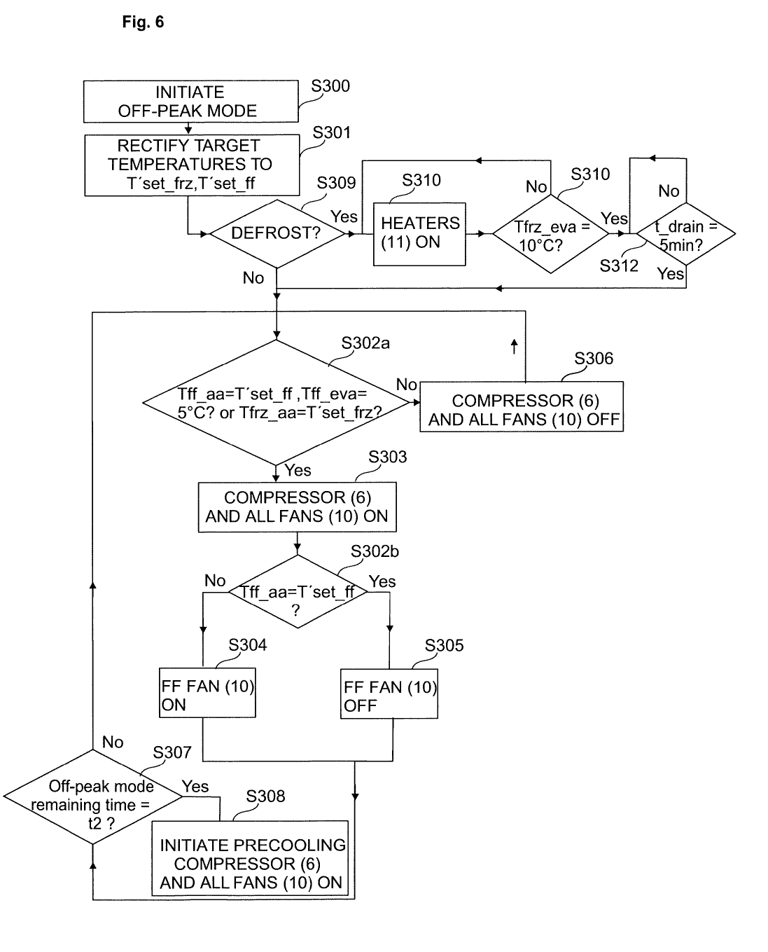

FIG. 6—is a flow chart showing a method for controlling the refrigerator in an off-peak mode according to an embodiment of the present invention;

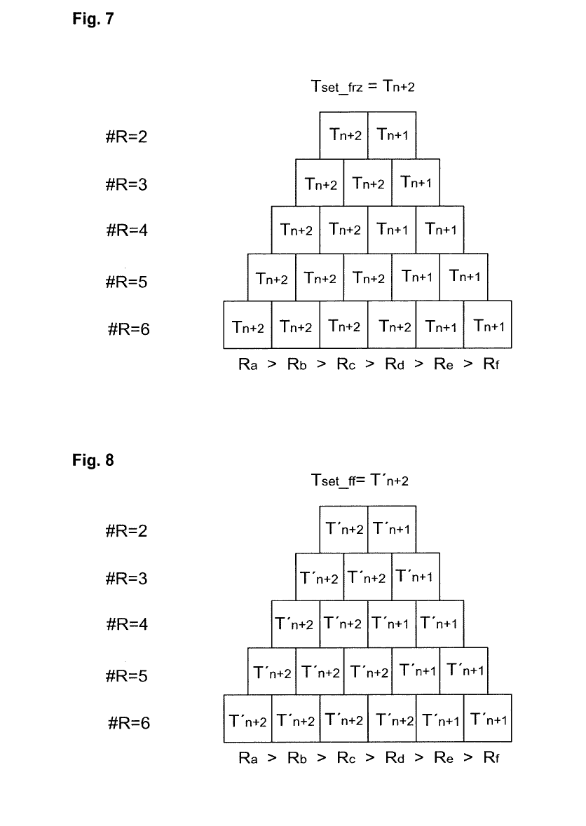

FIG. 7—is a chart showing a procedure for rectifying in accordance with a number of different rates, a maximum target temperature set for the freezer compartment according to an embodiment of the present invention;

FIG. 8—is a chart showing a procedure for rectifying in accordance with a number of different rates, a maximum target temperature set for the fresh food compartment according to an embodiment of the present invention;

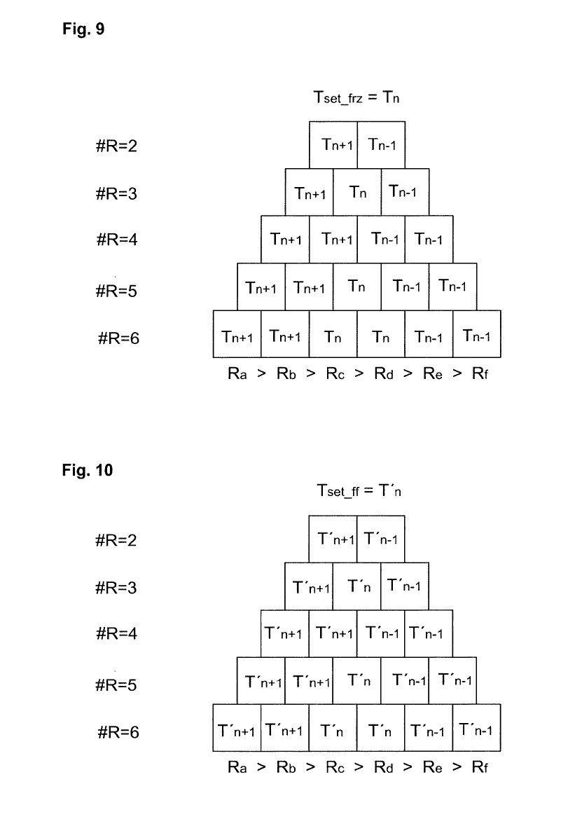

FIG. 9—is a chart showing a procedure for rectifying in accordance with a number of different rates, an intermediate target temperature set for the freezer compartment according to an embodiment of the present invention;

FIG. 10—is a chart showing a procedure for rectifying in accordance with a number of different rates, an intermediate target temperature set for the fresh food compartment according to an embodiment of the present invention;

FIG. 11—is a chart showing a procedure for rectifying, in accordance with a number of different rates a minimum target temperature set for the freezer compartment according to an embodiment of the present invention;

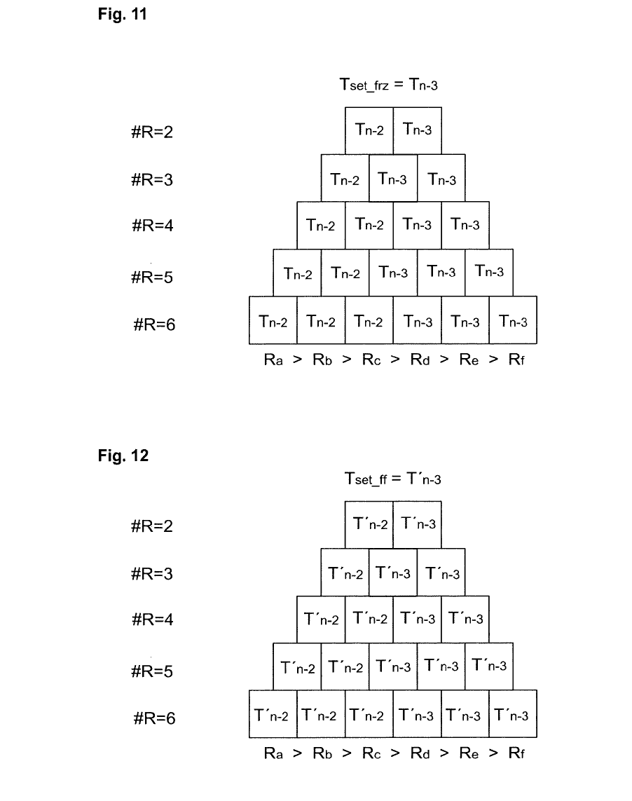

FIG. 12—is a chart showing a procedure for rectifying in accordance with a number of different rates, a minimum target temperature set for the fresh food compartment according to an embodiment of the present invention;

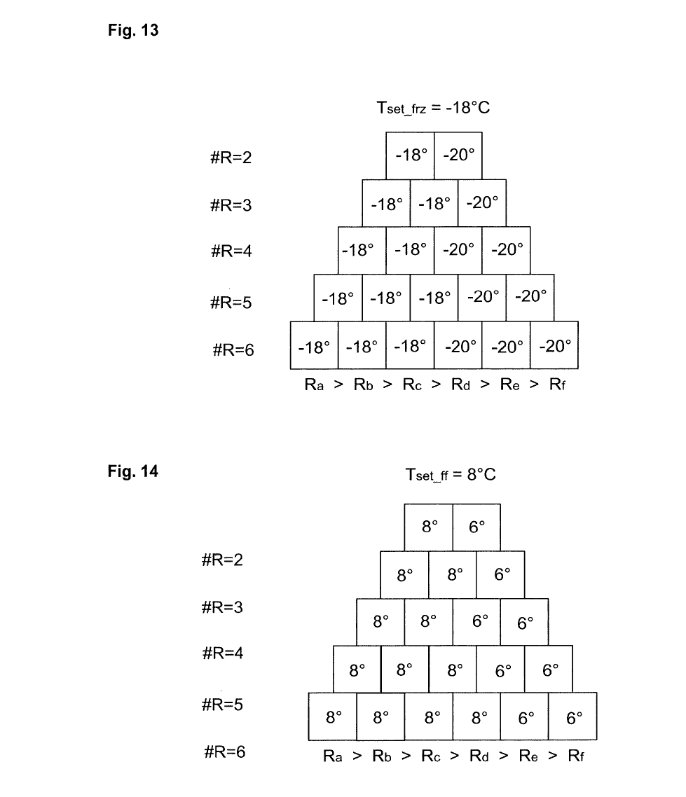

FIG. 13—is a chart showing a procedure for rectifying in accordance with a number of different rates, a maximum target temperature of −18° C. set for the freezer compartment according to an embodiment of the present invention;

FIG. 14—is a chart showing a procedure for rectifying in accordance with a number of different rates, a maximum target temperature of 8° C. set for the fresh food compartment according to an embodiment of the present invention;

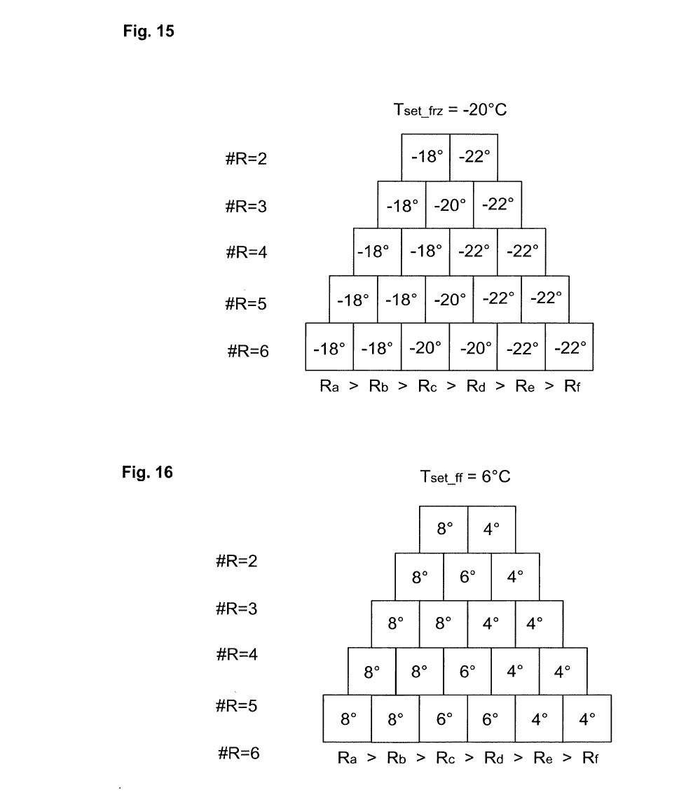

FIG. 15—is a chart showing a procedure for rectifying in accordance with a number of different rates, an intermediate target temperature of —20° C. set for the freezer compartment according to an embodiment of the present invention;

FIG. 16—is a chart showing a procedure for rectifying in accordance with a number of different rates, an intermediate target temperature of 6° C. set for the fresh food compartment according to an embodiment of the present invention.

The reference signs appearing on the drawings relate to the following technical features.
1. Refrigerator
2. Freezer evaporator
3. Fresh food evaporator
4. User interface
5. Control unit
6. Compressor
7. Condenser
8. Freezer compartment
9. Fresh food compartment
10. Fans
11. Heater

The refrigerator (1) comprises: a refrigeration circuit which includes: a compressor (6); a condenser (7); a capillary; a freezer evaporator (2); and a fresh food evaporator (3) which are serially arranged and fluidly connected to one another by respective lines for circulating a refrigerant (FIG. 1). The freezer evaporator (2) and the fresh food evaporator (3) are arranged to respectively refrigerate a freezer compartment (8) and a fresh food compartment (9) (FIG. 1).

The refrigerator (1) of the present invention further comprises: a defrost circuit which includes: means for defrosting the freezer evaporator (2) and the fresh food evaporator (3), and fans (10) which are respectively provided for the freezer evaporator (2) and the fresh food evaporator (3); a user interface (4); and a control unit (5) for controlling the refrigeration circuit, the defrost circuit and the user interface (4) (FIG. 1). The control unit (5) has a normal mode and an energy management mode (FIG. 2). The control unit (5) is configured to execute, in the energy management mode, the control method of the present invention (FIG. 2).

In an embodiment, the means for defrosting the freezer evaporator (2) and the fresh food evaporator (3) are configured by electrical heaters (11) (FIG. 1).

In an alternative embodiment, a hot gas defrost techniques is utilized. In this embodiment, the means for defrosting the freezer evaporator (2) and the fresh food evaporator (3) are configured by a bypass line (not shown) and a respective valve unit (not shown) for circulating through the evaporators (2,3) to be defrosted, hot refrigerant which is output by the compressor (6).

In another embodiment, the refrigerator (1) has two freezer evaporators (2) and one fresh food evaporator (3) (FIG. 1).

The control method of the present invention comprises: a step (S1) of setting a target temperature Tset_frz and a target temperature Tset_ff respectively for the freezer evaporator (2) and the fresh food evaporator (3) by selecting out of a plurality of preset temperatures (FIGS. 2 and 3). The plurality of preset temperatures respectively include: a maximum preset temperature, one or more than one intermediate preset temperature, and a minimum preset temperature respectively for the freezer evaporator (2) and the fresh food evaporator (3) (FIG. 3). The control method of the present invention further comprises: a step (S2) of initiating the energy management mode via the user interface (4) (FIGS. 1 and 2). The control method of the present invention further comprises: a step (S3) of defining or selecting time-of-use (TOU) rates for electricity via the user interface (4) (FIG. 2). The control method of the present invention further comprises a step (S4-S7, S100, S200, S300) of performing energy management by controlling the refrigeration circuit in accordance with target temperatures T′set_frz and T′set_ff as being rectified based on the time-of-use rates such that an operation duty of the refrigeration circuit is reduced during intervals of high rates and/or increased during interval of low rates, wherein the target temperatures T′set_frz and T′set_ff as being rectified do not fall outside the range which is inclusively defined by the respective maximum preset temperature and the minimum preset temperature (FIGS. 1 to 16).

In another embodiment, the refrigerator (1) has a maximum preset temperature Tn+2 for the freezer evaporator (2) and a maximum preset temperature Tn+2 for the fresh food evaporator (3) (FIG. 3). In this embodiment, the refrigerator (1) has a minimum preset temperature Tn−3 for the freezer evaporator (2) and a minimum preset temperature T′n−3 for the fresh food evaporator (3) (FIG. 3). In this embodiment, the refrigerator (1) has intermediate preset temperatures Tn+1, Tn, Tn−1, Tn−2 for the freezer evaporator (2) and intermediate preset temperatures T′n+1, T′n, T′n−1, T′n−2 for the fresh food evaporator (3) (FIG. 3). The user can select via the user interface (4) the target temperatures Tset_frz and Tset_ff (FIG. 3).

In another embodiment, the user defines the TOU rates by manually entering the necessary data via the user interface (4).

In another alternative embodiment, the user selects via the user interface (4) the TOU rates which are retrieved from a local energy provider by means of wired or wireless communication and the like.

In another embodiment, the control method includes: a step (S4) of determining based on the time-of-use rates, a highest rate, where applicable, one or more than one intermediate rate, and a lowest rate which respectively define an on-peak rate Ra, at least one intermediate-peak rate Rb, and an off-peak rate Rc (FIG. 2). In this embodiment, the control method further includes: a step (S5-S7) of determining based on the current time, a current peak rate among the on-peak rate Ra, said at least one intermediate-peak rate Rb, and the off-peak rate Rc (FIG. 2). In this embodiment, the control method further includes: a step (S100, S200, S300) of initiating based on the current peak rate a corresponding one of an on-peak mode, intermediate-peak mode, and an off-peak mode (FIG. 2). In this embodiment, the control method further includes: a step (S101, S201, S301) of rectifying based on the current peak rate and the number of different rates, the target temperature Tset_frz and the target temperature Tset_ff by modifying them respectively through a preset temperature (FIGS. 4 to 6). In this embodiment, the control method further includes: a step (S102a-S106; S202a-S208; S302a-S312) of controlling the refrigeration circuit and the defrost circuit in accordance with the rectified target temperature T′set_frz and the rectified target temperature T′set_ff (FIGS. 4 to 6). The rectified target temperatures T′set_frz and T′set_ff do not assume values that fall outside the preset temperatures available for the setting operation (FIG. 3).

In another embodiment, the control method includes: a step of determining whether the target temperature Tset_frz is a maximum preset temperature Tn+2 (FIG. 7). In this embodiment, the control method further includes: a step of decreasing said target temperature Tset_frz to a next lower preset temperature Tn+1 if the current peak rate is an off-peak rate Rc and said target temperature Tset_frz is a maximum preset temperature Tn+2 (FIG. 7). In this embodiment, the number of different rates R equals 3 (FIG. 7). Thus, the TOU rates include a highest rate Ra, an intermediate rate Rb and a lowest rate Rc (FIG. 7). In this embodiment, the control method further includes: a step of retaining said target temperature Tset_frz unchanged if the current rate is an intermediate-peak rate Rb and said target temperature Tset_frz is a maximum preset temperature Tn+2 (FIG. 7). In this embodiment, the control method further includes: a step of retaining said target temperature Tset_frz unchanged if the current peak rate is an on-peak rate Ra and said target temperature Tset_frz is a maximum preset temperature Tn+2 (FIG. 7). In this embodiment, the decreased or unchanged target temperature defines the rectified target temperature T′set_frz (FIGS. 4 to 6). Thereby, the refrigerator (1) performs additional cooling of the freezer compartment (8) in the off-peak interval where the off-peak rate is applicable (FIG. 7). The additional cooling reduces the load on the refrigeration circuit during the on-peak interval where the on-peak rate is applicable and during the intermediate-peak interval where the intermediate-peak rate is applicable. Thereby, the refrigerator saves energy costs. Whereas in the on-peak interval, the target temperature Tn+2, i.e., the maximum target temperature, is not changed, in particularly not increased (FIG. 7). Thereby, the food in the freezer compartment (8) is reliably refrigerated throughout the on-peak interval without causing health risks due to insufficient refrigeration.

In another embodiment, the control method includes: a step of determining whether the target temperature Tset_ff is a maximum preset temperature T′n+2 (FIG. 8). In this embodiment, the control method further includes: a step of decreasing said target temperature Tset_ff to a next lower preset temperature T′n+1 if the current peak rate is an off-peak rate Rc and said target temperature Tset_ff is a maximum preset temperature Tn+2 (FIG. 8). In this embodiment, the number of different rates R equals 3 (FIG. 8). Thus, the TOU rates include a highest rate Ra, an intermediate rate Rb and a lowest rate Rc (FIG. 8). In this embodiment, the control method further includes: a step of retaining said target temperature Tset_ff unchanged if the current rate is an intermediate-peak rate Rb and said target temperature Tset_ff is a maximum preset temperature T′n+2 (FIG. 8). In this embodiment, the control method further includes: a step of retaining said target temperature Tset_ff unchanged if the current peak rate is an on-peak rate Ra and said target temperature Tset_ff is a maximum preset temperature T′n+2 (FIG. 8). In this embodiment, the decreased or unchanged target temperature defines the rectified target temperature T′set_ff (FIGS. 4 to 6). Thereby, the above effect attained for the freezer compartment (8), is also attained for the fresh food compartment (9). Thus, the refrigerator (1) performs additional cooling of the fresh food compartment (9) in the off-peak interval (FIG. 8). The additional cooling reduces the load on the refrigeration circuit during the on-peak interval and the intermediate-peak interval. Thereby, the refrigerator saves energy costs. Whereas in the on-peak interval, the target temperature T′n+2, i.e., the maximum target temperature, is not changed, in particularly not increased (FIG. 8). Thereby, the food in the fresh food compartment (9) is reliably refrigerated throughout the on-peak interval without causing any health risks.

In another embodiment, the control method includes: a step of determining whether the target temperature Tset_frz is an intermediate preset temperature e.g., Tn (FIG. 9). Other intermediate preset temperatures are Tn+1, Tn, Tn−1, Tn−2 (FIG. 3). In this embodiment, the control method further includes: a step of decreasing said target temperature Tset_frz to a next lower preset temperature e.g., Tn−1 if the current rate is an off-peak rate Rc and said target temperature is an intermediate preset temperature e.g. Tn (FIG. 9). In this embodiment, the number of different rates R equals 3 (FIG. 9). Thus, the TOU rates include a highest rate Ra, an intermediate rate Rb and a lowest rate Rc (FIG. 9). In this embodiment, the control method further includes: a step of retaining said target temperature Tset_frz unchanged if the current rate is an intermediate-peak rate Rb and said target temperature Tset_frz is an intermediate preset temperature e.g., Tn (FIG. 9). In this embodiment, the control method further includes: a step of increasing said target temperature Tset_frz to a next higher preset temperature Tn+1 if the current rate is an on-peak rate Ra and said target temperature is an intermediate preset temperature e.g. Tn (FIG. 9). In this embodiment, the decreased or unchanged or increased target temperature defines the rectified target temperature T′set_frz (FIGS. 4 to 6). Thereby, the refrigerator (1) performs additional cooling of the freezer compartment (8) in the off-peak interval (FIG. 9). The additional cooling reduces the load on the refrigeration circuit during the on-peak interval and the intermediate-peak interval. Thereby, the refrigerator saves energy costs. In addition, in the on-peak interval, the target temperature Tn, i.e., the intermediate target temperature, is increased to a higher preset temperature to save further costs (FIG. 9). Thereby, the food in the freezer compartment (8) is still reliably refrigerated throughout the on-peak interval without causing any health risks.

In another embodiment, the control method includes: a step of determining whether the target temperature Tset_ff is an intermediate preset temperature e.g., T′n (FIG. 10). Other intermediate preset temperatures are T′n+1, T′n, T′n−1, T′n−2 (FIG. 3). In this embodiment, the control method further includes: a step of decreasing said target temperature Tset_ff to a next lower preset temperature e.g., T′n−1 if the current rate is an off-peak rate Rc and said target temperature is an intermediate preset temperature e.g. Tn (FIG. 10). In this embodiment, the number of different rates R equals 3 (FIG. 10). Thus, the TOU rates include a highest rate Ra, an intermediate rate Rb and a lowest rate Rc (FIG. 10). In this embodiment, the control method further includes: a step of retaining said target temperature Tset_ff unchanged if the current rate is an intermediate-peak rate Rb and said target temperature Tset_ff is an intermediate preset temperature e.g., Tn (FIG. 10). In this embodiment, the control method further includes: a step of increasing said target temperature Tset_ff to a next higher preset temperature T+n+1 if the current rate is an on-peak rate Ra and said target temperature is an intermediate preset temperature e.g. T′n (FIG. 10). In this embodiment, the decreased or unchanged or increased target temperature defines the rectified target temperature T′set_ff (FIGS. 4 to 6). Thereby, the above effect attained for the freezer compartment (8), is also attained for the fresh food compartment (9). Thus, the refrigerator (1) performs additional cooling of the fresh food compartment (9) in the off-peak interval (FIG. 10). The additional cooling reduces the load on the refrigeration circuit during the on-peak interval and the intermediate-peak interval. Thereby, the refrigerator saves energy costs. In addition, in the on-peak interval, the target temperature T′n, i.e., the intermediate target temperature, is increased to a next higher preset temperature to save costs (FIG. 10). Thereby, the food in the fresh food compartment (9) is reliably refrigerated throughout the on-peak interval without causing any health risks.

In another embodiment, the control method includes: a step of determining whether the target temperature Tset_frz is a minimum preset temperature Tn−3 (FIG. 11). In this embodiment, the control method further includes: a step of retaining said target temperature Tset_frz unchanged if the current rate is an off-peak rate Rc and said target temperature Tset_frz is a minimum temperature Tn−3 (FIG. 11). In this embodiment, the number of different rates R equals 3 (FIG. 11). Thus, the TOU rates include a highest rate Ra, an intermediate rate Rb and a lowest rate Rc (FIG. 11). In this embodiment, the control method further includes: a step of retaining said target temperature Tset_frz unchanged if the current rate is an intermediate-peak rate Rb and said target temperature T′set_frz is a minimum preset temperature Tn−3 (FIG. 11). In this embodiment, the control method further includes: a step of increasing said target temperature Tset_frz to a next higher preset temperature Tn−2 if the current rate is an on-peak rate Ra and said target temperature Tset_frz is a minimum preset temperature Tn−3 (FIG. 11). In this embodiment, the unchanged or increased target temperature defines the rectified target temperature Tset_frz (FIGS. 4 to 6). Thereby, in the off-peak interval, the target temperature Tn−3, i.e., the minimum target temperature, is not changed, thus not decreased (FIG. 11). Thereby, the food in the freezer compartment (8) is prevented from being excessively refrigerated throughout the off-peak interval. Whereas, the refrigerator (1) performs less cooling of the freezer compartment (8) in the on-peak interval to save energy costs (FIG. 11). Thereby, the food in the freezer compartment (8) is still reliably refrigerated throughout the on-peak interval without causing any health risks.

In another embodiment, the control method includes: a step of determining whether the target temperature Tset_ff is a minimum preset temperature T′n−3 (FIG. 12). In this embodiment, the control method further includes: a step of retaining said target temperature Tset_ff unchanged if the current rate is an off-peak rate Rc and said target temperature Tset_ff is a minimum temperature T′n−3 (FIG. 12). In this embodiment, the number of different rates R equals 3 (FIG. 12). Thus, the TOU rates include a highest rate Ra, an intermediate rate Rb and a lowest rate Rc (FIG. 12). In this embodiment, the control method further includes: a step of retaining said target temperature Tset_ff unchanged if the current rate is an intermediate-peak rate Rb and said target temperature T′set_ff is a minimum preset temperature T′n−3 (FIG. 12). In this embodiment, the control method further includes: a step of increasing said target temperature Tset_ff to a next higher preset temperature T′n−2 if the current rate is an on-peak rate Ra and said target temperature Tset_ff is a minimum preset temperature T′n−3 (FIG. 12). In this embodiment, the unchanged or increased target temperature defines the rectified target temperature T′set_ff (FIGS. 4 to 6). Thereby, in the off-peak interval, the target temperature T′n−3, i.e., the minimum target temperature, is not changed, in particular not decreased (FIG. 12). Thereby, the food in the fresh food compartment (9) is prevented from being excessively refrigerated throughout the off-peak interval. In addition, the refrigerator (1) performs less cooling of the fresh food compartment (9) in the on-peak interval to save energy costs (FIG. 12). Thereby, the food in the fresh food compartment (9) is still reliably refrigerated throughout the on-peak interval without causing any health risks.

In another embodiment, the control method includes: a step (S102a,S102b; S202a,S202b;S302a,S302b) of respectively measuring a temperature Tff_aa and a temperature Tfrz_aa of an ambient air inside the freezer compartment (8) and the fresh food compartment (9) (FIGS. 4 to 6). In this embodiment, the refrigerator (1) has respective temperature sensors (not shown). In this embodiment, the control method includes: a step (S103-S106; S203-S208; S303-S312) of controlling the compressor (6) and the fans (10) based on the measurements, so as to refrigerate the freezer compartment (8) and the fresh food compartment (9) in order to approach the rectified target temperature T′set_frz and the rectified target temperature T′set_ff (FIGS. 4 to 6). Thereby, the refrigerator (1) saves energy costs by respectively refrigerating the freezer compartment (8) and the fresh food compartment (9) at rectified temperatures T′set_frz and temperature T′set_ff which have been obtained through the charts (FIGS. 7 to 12). The refrigerator (1) has a non-volatile memory which stores the charts in form of a look-up table (LUT) (FIGS. 7 to 12). Specific numerical values of the preset temperature depend on the standardized preset temperatures (not shown) which are prescribed for proper refrigeration conditions (FIG. 3). The present invention also provides some numerical examples for the charts (FIGS. 13 to 16). These examples are not exhaustive.

In another embodiment, the control method includes: a step (S207) of determining a remaining time for an interval which corresponds to the intermediate-peak rate Rb to elapse (FIG. 5). In this embodiment, the control method includes: a step (S208) of precooling the freezer compartment (8) and the fresh food compartment (9) by controlling the compressor (6) and the fans (10) if the remaining time is less than a first duration t1. The precooling is continued until a cut-out temperate is reached (FIG. 5). Thereby, the refrigerator (1) performs additional cooling of the freezer compartment (8) and the fresh food compartment (9) in the intermediate-peak interval (FIG. 5). The additional cooling reduces the load on the refrigeration circuit during the subsequent intervals.

In another embodiment, the control method includes: a step (S307) of determining a remaining time for an interval which corresponds to an off-peak rate Rc to elapse (FIG. 6). In this embodiment, the control method further includes: a step (S308) of precooling each of the freezer compartment (8) and the fresh food compartment (9) by controlling the compressor (6) and the fans (10) if the remaining time is less than a second duration t2. The precooling is continued until a cut-out temperate is reached (FIG. 6).

In another embodiment, the precooling process is not applied in the on-peak mode (FIG. 4).

In another embodiment, the control method includes: a step of setting the first duration t1 and the second duration t2 via the user interface (4). Thereby, the user can decide on an extent of energy management to be applied by the refrigerator (1).

In another embodiment, the control method includes: a step of informing a user, during an interval corresponding to the on-peak rate Ra, about the current on-peak rate Ra if the user selects via the user interface (4) at least one of a fast cooling function and a fast freezing function respectively for the freezer compartment (8) and the fresh food compartment (9) (FIG. 1). In this embodiment, the control method further includes: a step of executing said functions only if the user inputs an approval via the user interface (4) after having been informed on the current on-peak rate Ra (FIG. 1). Thereby, the energy consumption is generally suppressed unless the user intentionally decides to perform rapid refrigeration. The aforementioned functions specially includes among others making of ice and the like.

In another embodiment, the control method includes: a step of defrosting

(S309-S312) the freezer evaporator (2) and/or the fresh food evaporator (3) (FIG. 6). In this embodiment, the step of defrosting is immediately performed at a beginning of an interval corresponding to the off-peak rate Rc (FIG. 6). The refrigeration performance of the refrigerator (1) is improved after termination of the defrost cycle. Thereby, the load on the refrigeration circuit during the on-peak interval and the intermediate-peak interval is even further reduced. Hence, the refrigerator (1) saves energy costs.

According to the control method of the present invention, the operation duty of refrigeration circuit is reduced during the on-peak interval and/or increased during the off-peak intervals. Thereby, a user having opted to time-based rates attains a substantial amount of reduction in energy costs by virtue of the energy management mode of the present invention. The control method of the present invention enables substantially constant temperatures in the freezer compartment (8) and the fresh food compartment (9) without insufficiently or excessively refrigerating the food. The available maximum and minimum preset temperature are respectively neither exceeded nor deceeded during the energy management mode. Hence, the energy management mode of the present invention is reliable in view of a consumer's health.

1. A method for controlling a refrigerator (1) comprising a refrigeration circuit which includes a freezer evaporator (2) and a fresh food evaporator (3), a defrost circuit, a user interface (4) and a control unit (5) for controlling the refrigeration circuit, the defrost circuit and the user interface (4), wherein the control unit (5) has a normal mode and an energy management mode, said method characterized in that comprising the steps of:—setting a target temperature Tset_frz and a target temperature Tset_ff respectively for the freezer evaporator (2) and the fresh food evaporator (3) by selecting out of a plurality of preset temperatures, wherein the plurality of preset temperatures respectively include: a maximum preset temperature, one or more than one intermediate preset temperature, and a minimum preset temperature respectively for the freezer evaporator (2) and the fresh food evaporator (3) (S1),—initiating the energy management mode via the user interface (4) (S2),—defining or selecting time-of-use rates for electricity via the user interface (4) (S3) and—performing energy management by controlling the refrigeration circuit in accordance with target temperatures T′set_frz and T′set_ff as being rectified based on the time-of-use rates such that an operation duty of the refrigeration circuit is reduced during intervals of high rates and/or increased during interval of low rates, wherein the target temperatures T′set_frz and T′set_ff as being rectified do not fall outside the range which is inclusively defined by the respective maximum preset temperature and the minimum preset temperature (S4-S7, S100, S200, S300).

2. The method according to claim 1, characterized in that the step (S4-S7, S100, S200, S300) of performing energy management comprising the steps of:—determining based on the time-of-use rates, a highest rate, where applicable, one or more than one intermediate rate, and a lowest rate which respectively define an on-peak rate Ra, at least one intermediate-peak rate Rb, and an off-peak rate Rc (S4),—determining based on the current time, a current peak rate among the on-peak rate Ra, said at least one intermediate-peak rate Rb, and the off-peak rate Rc (S5-S7),—initiating based on the current peak rate a corresponding one of an on-peak mode, intermediate-peak mode, and an off-peak mode (S100, S200, S300),—rectifying based on the current peak rate and the number of different rates, the target temperature Tset_frz and the target temperature Tset_ff by modifying them respectively through a preset temperature (S101, S201, S301),—controlling the refrigeration circuit and the defrost circuit in accordance with the rectified target temperature T′set_frz and the rectified target temperature T′set_ff (S102a-S106; S202a-5208; S302a-S312).

3. The method according to claim 2, characterized in that the step (S101, S201, S301) of rectifying the target temperature Tset_frz comprising the steps of:—determining whether the target temperature Tset_frz is a maximum preset temperature,—decreasing said target temperature Tset_frz to a next lower preset temperature if the current peak rate is an off-peak rate Rc and said target temperature Tset_frz is a maximum preset temperature,—retaining said target temperature Tset_frz unchanged if the current rate is an intermediate-peak rate Rb and said target temperature Tset_frz is a maximum preset temperature,—a step of retaining said target temperature Tset_frz unchanged if the current peak rate is an on-peak rate Ra and said target temperature Tset_frz is a maximum preset temperature, wherein the decreased or unchanged target temperature defines the rectified target temperature T′set_frz.

4. The method according to claim 1, characterized in that the step (S101, S201, S301) of rectifying the target temperature Tset_ff, comprising the steps of:—determining whether the target temperature Tset_ff is a maximum preset temperature,—decreasing said target temperature Tset_ff to a next lower preset temperature if the current peak rate is an off-peak rate Rc and said target temperature Tset_ff is a maximum preset temperature,—retaining said target temperature Tset_ff unchanged if the current rate is an intermediate-peak rate Rb and said target temperature Tset_ff is a maximum preset temperature,—retaining said target temperature Tset_frz unchanged if the current peak rate is an on-peak rate Ra and said target temperature Tset_ff is a maximum preset temperature, wherein the decreased or unchanged target temperature defines the rectified target temperature T′set_ff.

5. The method according to claim 1, characterized in that the step of rectifying (S101, S201, S301) the target temperature Tset_frz, comprising the steps of:—determining whether the target temperature Tset_frz is an intermediate preset temperature,—decreasing said target temperature Tset_frz to a next lower preset temperature if the current rate is an off-peak rate Rc and said target temperature is an intermediate preset temperature,—retaining said target temperature Tset_frz unchanged if the current rate is an intermediate-peak rate Rb and said target temperature Tset_frz is an intermediate preset temperature,—increasing said target temperature Tset_frz to a next higher preset temperature if the current rate is an on-peak rate Ra and said target temperature is an intermediate preset temperature, wherein the decreased or unchanged or increased target temperature defines the rectified target temperature T′set_frz.

6. The method according to claim 2, characterized in that the step of rectifying (S101, S201, S301) the target temperature Tset_ff, comprising the steps of:—determining whether the target temperature Tset_ff is an intermediate preset temperature,—decreasing said target temperature Tset_ff to a next lower preset temperature if the current rate is an off-peak rate Rc and said target temperature is an intermediate preset temperature,—retaining said target temperature Tset_ff unchanged if the current rate is an intermediate-peak rate Rb and said target temperature Tset_ff is an intermediate preset temperature,—increasing said target temperature Tset_ff to a next higher preset temperature if the current rate is an on-peak rate Ra and said target temperature is an intermediate preset temperature, wherein the decreased or unchanged or increased target temperature defines the rectified target temperature T′set_ff.

7. The method according to claim 2, characterized in that the step (S101, S201, S301) of rectifying the target temperature Tset_frz comprising the steps of:—determining whether the target temperature Tset_frz is a minimum preset temperature,—retaining said target temperature Tset_frz unchanged if the current rate is an off-peak rate Rc and said target temperature Tset_frz is a minimum temperature,—retaining said target temperature Tset_frz unchanged if the current rate is an intermediate-peak rate Rb and said target temperature T′set_frz is a minimum preset temperature and—increasing said target temperature Tset_frz to a next higher preset temperature if the current rate is an on-peak rate Ra and said target temperature Tset_frz is a minimum preset temperature, wherein the unchanged or increased target temperature defines the rectified target temperature T′set_frz.

8. The method according to claim 2, characterized in that the step (S101, S201, S301) of rectifying the target temperature Tset_ff comprising the steps of:—determining whether the target temperature Tset_ff is a minimum preset temperature,—retaining said target temperature Tset_ff unchanged if the current rate is an off-peak rate Rc and said target temperature Tset_ff is a minimum temperature,—retaining said target temperature Tset_ff unchanged if the current rate is an intermediate-peak rate Rb and said target temperature Tset_ff is a minimum preset temperature and—increasing said target temperature Tset_ff to a next higher preset temperature if the current rate is an on-peak rate Ra and said target temperature Tset_ff is a minimum preset temperature, wherein the unchanged or increased target temperature defines the rectified target temperature T′set_ff.

9. The method according to claim 2, characterized in that the step (S4-S7,S100, S200, S300) of performing energy management comprising the steps of:—respectively measuring a temperature Tff_aa and a temperature Tfrz_aa of an ambient air inside a freezer compartment (8) and a fresh food compartment (9) (S102a, S102b; S202a, S202b; S302a, S302b),—controlling based on the temperature Tff_aa and the temperature Tfrz_aa a compressor (6) and fans (10) so as to refrigerate the freezer compartment (8) and the fresh food compartment (9) and to approach the rectified target temperature T′set_frz and the rectified target temperature T′set_ff (S103-S106; S203-S208; S303-S312).

10. The method according to claim 2, characterized in that the step (S4-S7,S100, S200, S300) of performing energy management comprising the steps of:—determining a remaining time for an interval which corresponds to the intermediate-peak rate Rb to elapse (S207),—precooling a freezer compartment (8) and a fresh food compartment (9) by controlling a compressor (6) and fans (10), if the remaining time is less than a first duration t1, wherein the precooling is continued until a cut-out temperate is reached (S208).

11. The method according to claim 2, characterized in that the step (S4-S7,S100, S200, S300) of performing energy management comprising the steps of:—determining a remaining time for an interval which corresponds to an off-peak rate Rc to elapse (S307) and—precooling a freezer compartment (8) and a fresh food compartment (9) by controlling a compressor (6) and fans (10), if the remaining time is less than a second duration t2, wherein the precooling is continued until a cut-out temperate is reached (S308).

12. The method according to claim 10, characterized in that the step (S4-S7, S100, S200, S300) of performing energy management comprising a step of setting the first duration t1 and the second duration t2 via the user interface (4).

13. The method according to claim 2, characterized in that the step (S4-S7,S100, S200, S300) of performing energy management, comprising the steps of:—informing a user, during an interval corresponding to the on-peak rate Ra, about the current on-peak rate Ra if the user selects via the user interface (4) at least one of a fast cooling function and a fast freezing function respectively for a freezer compartment (8) and a fresh food compartment (9) and—executing said functions only if the user inputs an approval via the user interface (4) after having been informed on the current on-peak rate Ra.

14. The method according to claim 2, characterized in that the step (S4-S7, S100, S200, S300) of performing energy management comprising a step of defrosting (S309-S312) the freezer evaporator (2) and/or the fresh food evaporator (3), wherein the step of defrosting is immediately performed at a beginning of an interval corresponding to the off-peak rate Rc.

15. A refrigerator (1) comprising a refrigeration circuit comprising a compressor (6), a condenser (7), a capillary, a freezer evaporator (2) and a fresh food evaporator (3) which are serially arranged and fluidly connected to one another by respective lines for circulating a refrigerant, wherein the freezer evaporator (2) and the fresh food evaporator (3) are arranged to respectively refrigerate a freezer compartment (8) and a fresh food compartment (9), characterized in that a defrost circuit comprising means for defrosting the freezer evaporator (8) and the fresh food evaporator (9) and fans (10) respectively provided for the freezer evaporator (8) and the fresh food evaporator (9), a user interface (4) and a control unit (5) for controlling the refrigeration circuit, the defrost circuit and the user interface (4), wherein the control unit (5) has a normal mode and an energy management mode, and wherein the control unit (5) is configured to execute, in the energy management mode, the steps of the control method defined in claim 1.

16. The method according to claim 11, characterized in that the step (S4-S7, S100, S200, S300) of performing energy management comprising a step of setting the first duration t1 and the second duration t2 via the user interface (4).

17. The method according to claim 3, characterized in that the step (S101, S201, S301) of rectifying the target temperature Tset_ff, comprising the steps of:—determining whether the target temperature Tset_ff is a maximum preset temperature,—decreasing said target temperature Tset_ff to a next lower preset temperature if the current peak rate is an off-peak rate Rc and said target temperature Tset_ff is a maximum preset temperature,—retaining said target temperature Tset_ff unchanged if the current rate is an intermediate-peak rate Rb and said target temperature Tset_ff is a maximum preset temperature,—retaining said target temperature Tset_frz unchanged if the current peak rate is an on-peak rate Ra and said target temperature Tset_ff is a maximum preset temperature, wherein the decreased or unchanged target temperature defines the rectified target temperature T′set_ff.
